(19) United States
(12) Patent Application Publication
(10) Pub. No.: US 2007/0229217 A1
(43) Pub. Date: Oct. 4, 2007

(54) A RFID AUTOMATIC GUARDING SYSTEM FOR CAMPUS SAFETY

(75) Inventors: Shu-Mei Chen, Taipei (TW); Shu-Hui Hsu, Taipei (TW); Chun-Sho Lee, Taipei (TW); Tyan-An Pai, Taipei (TW)

Correspondence Address: PAI PATENT & TRADEMARK LAW FIRM, 1001 FOURTH AVENUE, SUITE 3200, SEATTLE, WA, 98154, US

(73) Assignee: PRETIDE HOLDINGS, INC., Road Town, Tortola (VG)

(21) Appl. No.: 11/308,512

(22) Filed: Mar. 31, 2006

(51) Int. Cl. G05B 19/00

(52) U.S. Cl. 340/5.61

(57) ABSTRACT

A RFID automatic guarding system for campus safety is disclosed, which applies active ultra high frequency (UHF) RFID technology. The system comprises hanging the RFID active tag on students; transmitting a signal from the RFID locator to the RFID active tag once the students go through general or restricted area where the RFID locator is sited; receiving a driving signal by the RFID active tag from the RFID locator; transmitting stored data from the RFID active tag to the RFID reader; transmitting the stored data from the RFID reader to a middleware server; integrating the stored data by the middleware server; transmitting the integrated data to an application server; meanwhile transmitting the integrated data to parents or school administrators, wherein the integrated data can be received by cellular phone or computer and shows message of arriving school, leaving school, breaking into restricted area, or overstaying on school bus of students.

### BACKGROUND OF THE INVENTION

1. Field of the Invention

The invention is about a RFID automatic guarding system for campus safety and more particularly to a campus-safety-guarding system applying an active ultra high frequency, UHF, RFID technology. With this invention, parents and school administrators can instantly monitor activities of the students, such as arriving school or leaving school; wandering into restricted areas; getting on or off the school bus, etc.

2. Description of the Prior Art

Recently, safety of students has become a very serious and important issue, for example, there were cases in which kindergarten students died from suffocation in school bus. Although nowadays school administrators are continuously enhancing safety in school, many parents still cannot feel easy and personally take students to and from school. However, it is not convenient to working parents, and safety of students on campus is still an issue. Prior art RFID applications for campus safety require students to go to a reader at a fixed location to scan the passive tag carried by the students. If students forget to or are unwilling to go through the process, the prior art system cannot assure safety. Moreover, usually a teacher on the school bus makes a roll call of students, but if the teacher does it negligently, students might be left in the school bus.

In view of the above-described deficiency of prior art, the inventors of this invention after years of constant effort in research have consequently developed and proposed a RFID automatic guarding system for campus safety.

### SUMMARY OF THE INVENTION

One objective of the invention is to provide a campus safety guarding system with active UHF RFID technology. Thus parents and school administrators can instantly monitor activities of the students, such as arriving school or leaving school; wandering into restricted areas; getting on or off the school bus, etc.

Another objective of the invention is to provide a system that allows the UHF RFID active tags worn by the students to transmit a stored data to the system when the students come into or go out of school, without having to ask students to go to the reader location. The system will transmit instantly an arriving message to the teacher or a leaving message to the custodians.

Another objective of the invention is to allow the RFID active tags to send an alert message back to the system via a RFID locator once the students get into restricted area; the administration and the guarding staff of school would be noted. Thus the RFID automatic guarding system will help track students' actions and allow timely actions to be taken. It reduces possible causalities when there is limited manpower on the school guarding staff.

Another objective of the invention is send an alert message back to the teacher on the school bus via a reader which receives a tag signal from the RFID active tag carried by the students, when the students are being forgotten on the school bus after the school bus is closed. Thus the system can prevent accidents arising from students being left unattended in the school bus.

To achieve the objective, the system of this invention comprises providing a RFID active tag to each student; having a RFID locator wake up RFID active tag once the students go through general or restricted area where the RFID locator is installed; transmitting a stored data from the RFID active tag to the RFID reader; forwarding the stored data from the RFID reader to an middleware server; integrating the stored data by the middleware server; forwarding the integrated data to an application server and storing it in a database; meanwhile sending the integrated data to custodians or administrators of school, wherein the integrated data can be received by cellular phone or computer and shows message of arriving school, leaving school, breaking into restricted area, or overstaying on school bus of students.

Thus, the invention of RFID automatic guarding system for campus safety is realized. The custodians or the administrators thus can get instant message related to the students and feel safe, or can track students on their way to or from school.

These features and advantages of the present invention will be fully understood and appreciated from the following detailed description of the preferred embodiments with reference to the accompanying Drawings.

### BRIEF DESCRIPTION OF THE DRAWINGS

FIG. 1 is a perspective view of the system structure of the invention;

FIGS. 2A and 2B are flow charts of the invention when students go into and out of school management, respectively;

FIGS. 3A and 3B are flow charts of the invention when students get on and off school bus management, respectively;

FIG. 4 is a flow chart of the invention of restricted area management; and

FIG. 5 is another perspective view of the system structure of the invention.

### DETAILED DESCRIPTION OF THE PREFERRED EMBODIMENT

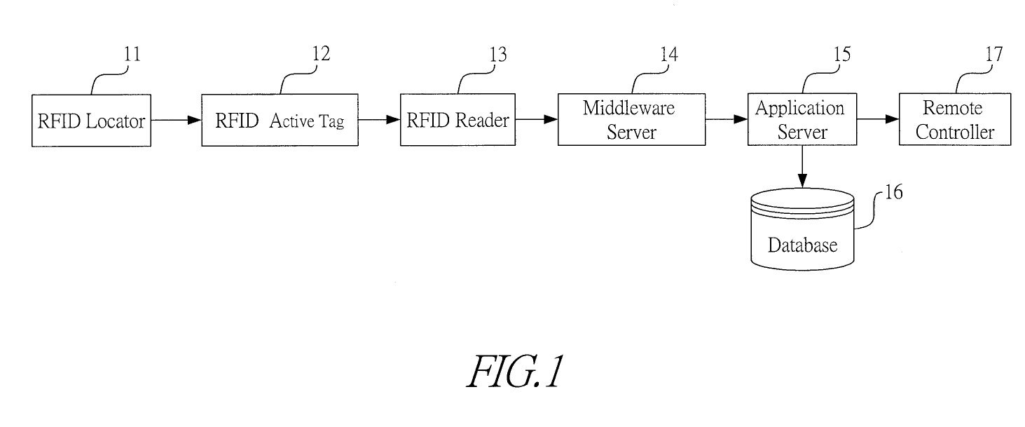

Referring to FIG. 1, the RFID automatically guarding system for campus safety comprises:

a RFID locator 11, wherein the RFID locator 11 can detect an RFID active tag 12 carried by students, and send driving signal to the RFID active tag 12; the RFID locator 11 can be sited on general area, restricted area, or other areas, wherein the general area can be set nearby the gate, the classroom, or be set on the school bus and the restricted area can be set nearby the loft, the transformer box, or the basement;

the RFID active tag 12 driven by the driving signal from the RFID locator 11, wherein the RFID active tag 12 can store related data of students and be carried by students, thus the RFID active tag 12 is driven and transmits stored data to a RFID reader 13 once students go through the detecting scope of the RFID locator 11 sited on general area or restricted area; the stored data, which is basic information or other related information about the students;

the RFID reader 13, which receives the stored data from the RFID active tag 12, and transmits it to a middleware server 14;

the middleware server 14, which receives all data of students from each RFID reader 13, and integrates all data; and

an application server 15, which receives the data of all students from the middleware server 14, stores the data in a database 16, and transmits the data to a remote controller 17 by a message transmission method, wherein the message transmission method can be via cellular phone, computer, or other applications, and the remote controller 17 can be parents, school administrators, guarding staff of school, or other relevant personnel;

As described above, the invention of RFID automatic guarding system for campus safety is realized. The parents or the administrators thus can get instant message about children arriving school, leaving school, or overstaying on school bus and feel assured, and can track children on their way to or from school. Besides, if students break into a restricted area, the school administrators and guarding staff will receive the message, then they can take proper actions to prevent students from danger.

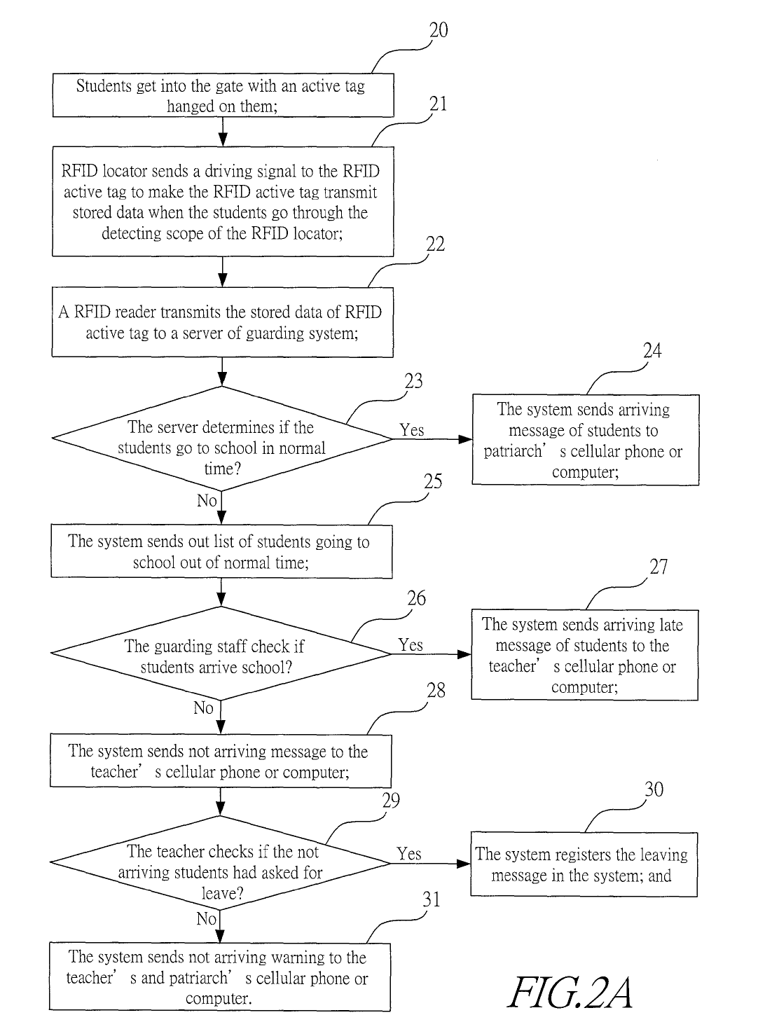

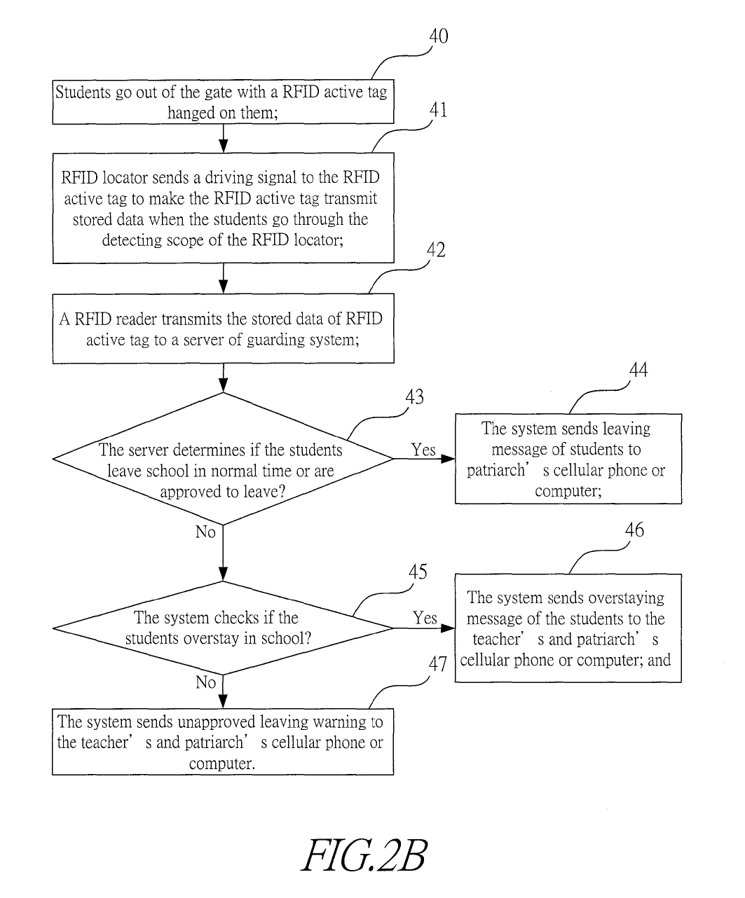

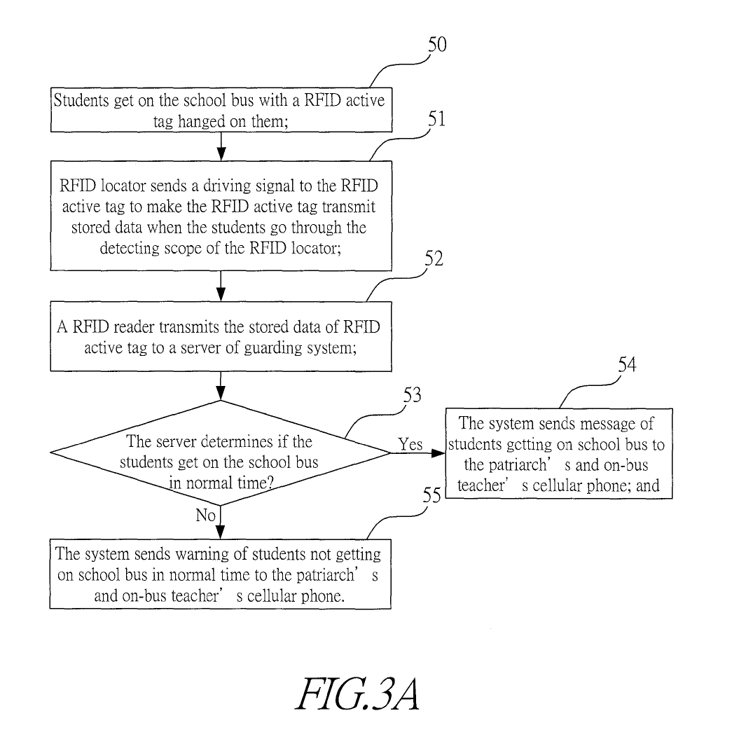

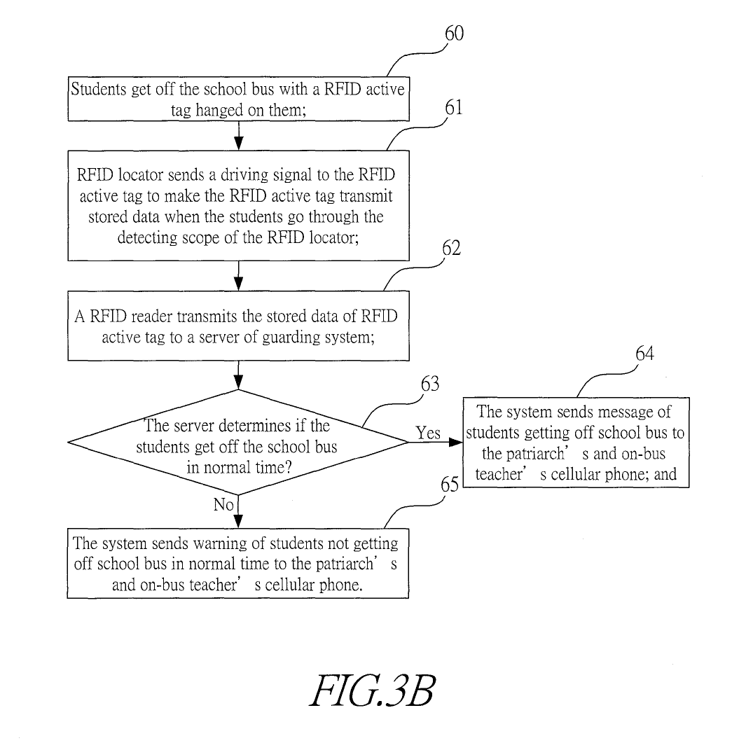

Referring to FIGS. 2A, 2B, 3A, and 3B, wherein coming into and going out of the gate and taking school bus are given as examples of general area management. In FIG. 2A, the flow chart runs as follows:

20: students get into the gate with an RFID active tag carried by them;

21: the RFID locator sends a driving signal to the RFID active tag to make the RFID active tag transmit stored data when the students go through the detecting scope of the RFID locator;

22: a RFID reader transmits the stored data of RFID active tag to a server of the guarding system;

23: the server determines if the students go to school in normal time;

If yes, then the flow goes to 24: the system sends arriving message of students to the parents' cellular phone or computer;

If no, then the flow goes to 25: the system sends out list of students going to school out of normal time;

26: the guarding staff checks if students arrive school;

If yes, then the flow goes to 27: the system sends arriving late message of students to the teacher's cellular phone or computer;

If no, then the flow goes to 28: the system sends not arriving message to the teacher's cellular phone or computer;

29: the teacher checks if the not arriving students had asked for leave;

If yes, then the flow goes to 30: the system registers the leaving message in the system; and

If no, then the flow goes to 31: the system sends not arriving warning to the teacher's and parents' cellular phone or computer.

In FIG. 2B, the flow chart runs as follows:

40: students go out of the gate with an RFID active tag carried by them;

41: the RFID locator sends a driving signal to the RFID active tag to make the RFID active tag transmit stored data when the students go through the detecting scope of the RFID locator;

42: a RFID reader transmits the stored data of RFID active tag to a server of the guarding system;

43: the server determines if the students leave school in normal time or are approved to leave;

If yes, then the flow goes to 44: the system sends leaving message of students to the parents' cellular phone or computer;

If no, then the flow goes to 45: the system checks if the students overstay in school;

If yes, then the flow goes to 46: the system sends overstaying message of the students to the teacher's and parents' cellular phone or computer; and

If no, then the flow goes to 47: the system sends unapproved leaving warning to the teacher's and parents' cellular phone or computer.

In FIG. 3A, the flow chart runs as follows:

50: students get on the school bus with an RFID active tag carried by them;

51: the RFID locator sends a driving signal to the RFID active tag to make the RFID active tag transmit stored data when the students go through the detecting scope of the RFID locator;

52: a RFID reader transmits the stored data of RFID active tag to a server of the guarding system;

53: the server determines if the students get on the school bus in normal time;

If yes, then the flow goes to 54: the system sends message of students getting on school bus to the parents' and the on-bus teacher's cellular phone; and

If no, then the flow goes to 55: the system sends warning of students not getting on school bus in normal time to the parents' and the on-bus teacher's cellular phone.

In FIG. 3B, the flow chart runs as follows:

60: students get off the school bus with an RFID active tag carried by them;

61: the RFID locator sends a driving signal to the RFID active tag to make the RFID active tag transmit stored data when the students go through the detecting scope of the RFID locator;

62: a RFID reader transmits the stored data of RFID active tag to a server of the guarding system;

63: the server determines if the students get off the school bus in normal time;

If yes, then the flow goes to 64: the system sends message of students getting off school bus to the parents' and the on-bus teacher's cellular phone; and

If no, then the flow goes to 65: the system sends warning of students not getting off school bus in normal time to the parents' and the on-bus teacher's cellular phone.

The general area can be other acres and the system can send different instant messages to relevant personnel according to different setting requirement.

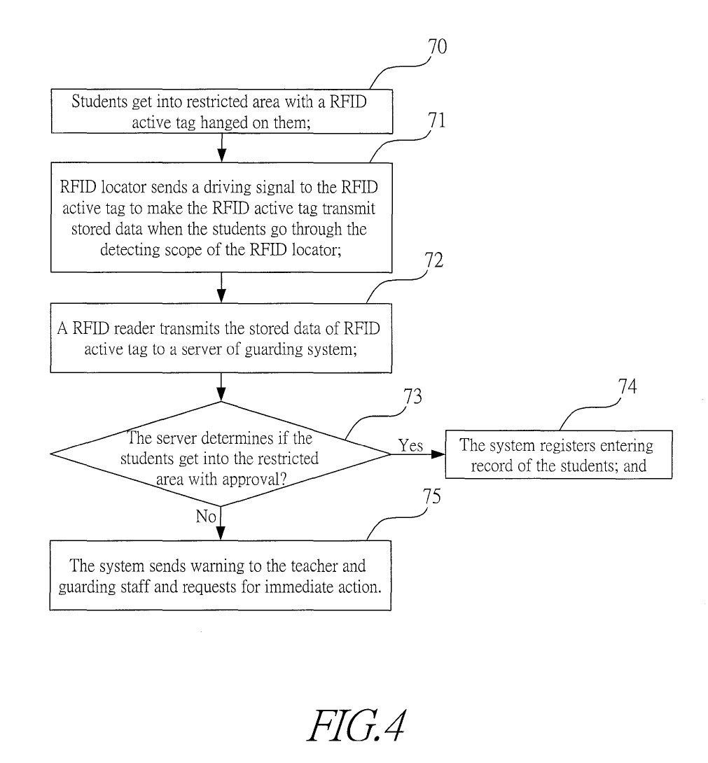

In FIG. 4, the flow chart runs as follows:

70: students get into restricted area with an RFID active tag carried by them;

71: the RFID locator sends a driving signal to the RFID active tag to make the RFID active tag transmit stored data when the students go through the detecting scope of the RFID locator;

72: a RFID reader transmits the stored data of RFID active tag to a server of guarding system;

73: the server determines if the students get into the restricted area with approval;

If yes, then the flow goes to 74: the system registers entering record of the students; and

If no, then the flow goes to 75: the system sends warning to the teacher and guarding staff and requests for immediate action.

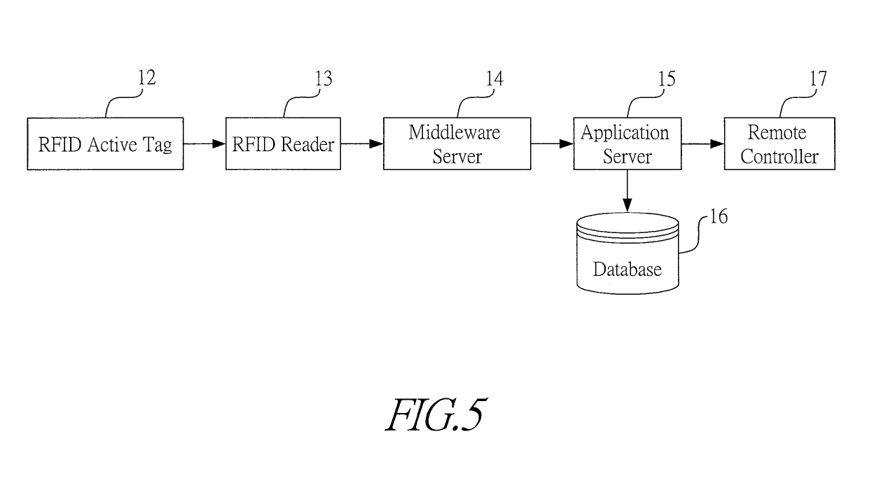

FIG. 5 shows another perspective view of the system structure of the invention, which comprises:

an RFID active tag 12 which can store related data and transmit the data to a RFID reader 13, wherein the RFID active tag 12 can store related data of students and be carried by students, thus the RFID active tag 12 transmits stored data to the RFID reader 13 once students go through the detecting scope of the RFID reader 13 sited on general area or restricted area, wherein the general area can be set nearby the gate, the classroom, or be set on the school bus and the restricted area can be set nearby the loft, the transformer box, or the basement; the stored data, which is basic information or other related information of students; and

an application server 15, which receives the data of all students from the middleware server 14, stores the data in a database 16, and transmits the data to a remote controller 17 by a certain message transmission method, wherein the message transmission method can be via cellular phone, computer, or other applications, and the remote controller 17 can be parents, administrators of school, guarding staff of school, or other relevant personnel.

By the system, the parents and school administrators can track student's whereabouts, and prevent students from breaking into restricted area and getting into danger.

The RFID automatic guarding system for campus safety of this invention is more advantageous than prior art in the following respects:

1. The invention provides a campus-safety-guarding system with UHF RFID technology. Thus parents and school administrators can instantly monitor activities of the students, such as arriving school or leaving school; wandering into restricted areas; getting on or off the school bus, etc.

2. The invention provides a UHF RFID active tag carried by the students. Thus the students do not have to go to a reader location, but the RFID active tag transmits stored data to the system once the students go into or out of school. Then the system transmits instant message to the teacher or arriving or leaving message to parents.

3. The invention provides a function of the system transmitting signal back to the system via a RFID locator once the students get into restricted area, and the administrators and guarding staff of school would be noted. Thus the system can reduce dangerous risk of students even with limited manpower.

4. The invention provides a function of the system transmitting a signal back to the teacher on the school bus via a reader which receives a tag signal from the RFID active tag carried by the students, once the students get on the school bus. Thus the system can reduce the probability of students overstaying in the school bus.

Many changes and modifications in the above described embodiment of the invention can, of course, be carried out without departing from the scope thereof. Accordingly, the invention is to be limited only by the scope of the appended claims.

What is claimed is:

1. A RFID automatic guarding system for campus safety, which comprises:
a RFID locator, wherein the RFID locator can detect an RFID active tag carried by a user, and send a driving signal to the RFID active tag;
the RFID active tag, which is driven by the driving signal from the RFID locator to transmit data to a RFID reader, wherein the RFID active tag stores related data of user;
the RFID reader, which receives the stored data from the RFID active tag, and transmits it to a middleware server;
the middleware server, which receives all data from each RFID reader, and integrates all data; and
an application server, which receives the data from the middleware server, stores the data in a database, and transmits the data to a remote controller by a message transmission method.

2. The system of claim 1, wherein the RFID locator is sited on a general area or a restricted area.

3. The system of claim 2, wherein the general area is set nearby the gate, the classroom, or set on the school bus.

4. The system of claim 2, wherein the restricted area is set nearby the loft, the transformer box, or the basement.

5. The system of claim 1, wherein the stored data in the active tag is basic information of the user.

6. The system of claim 1, wherein the RFID active tag stores related data of user and is carried by the user, thus the RFID active tag is driven and transmits stored data to the RFID reader once user goes through the detecting scope of the RFID locator sited on general area or restricted area.

7. The system of claim 1, wherein the middleware server integrates all received data.

8. The system of claim 1, wherein the message transmission method is receiving transmitted message by cellular phone or computer.

9. The system of claim 1, wherein the remote controller is a parent, school administrator, or guarding staff member.

10. A RFID automatically guarding system for campus safety, which comprises:
an RFID active tag, which stores related data and transmits the data to a RFID reader;
the RFID reader, which receives the stored data from the RFID active tag, and transmits it to a middleware server;
the middleware server, which receives all data from each RFID reader; and
an application server, which receives the data from the middleware server, stores the data in a database, and transmits the data to a remote controller by a message transmission method.

11. The system of claim 10, wherein the general area is set nearby the gate, the classroom, or set on the school bus, which is set up upon requirement.

12. The system of claim 10, wherein the restricted area is set nearby the loft, the transformer box, or the basement, which is set up upon requirement.

13. The system of claim 10, wherein the stored data in the active tag is basic information of the user.

14. The system of claim 10, wherein the RFID active tag stores related data of user and is carried by user, thus the RFID active tag transmits stored data to the RFID reader once user goes through detecting scope of the RFID reader sited on general area or restricted area.

15. The system of claim 10, wherein the middleware server integrates all received information.

16. The system of claim 10, wherein the message transmission method is receiving transmitted message by cellular phone or computer.

17. The system of claim 10, wherein the remote controller is a parent, school administrator, or guarding staff member.
